(19) United States
(12) Patent Application Publication
(10) Pub. No.: US 2013/0258687 A1
(43) Pub. Date: Oct. 3, 2013

(54) Backplane, Backlight Module and LCD device

(71) Applicants: Chong Huang, Shenzhen (CN); Yicheng Kuo, Shenzhen (CN); Yuchun Hsiao, Shenzhen (CN)

(72) Inventors: Chong Huang, Shenzhen (CN); Yicheng Kuo, Shenzhen (CN); Yuchun Hsiao, Shenzhen (CN)

(21) Appl. No.: 13/376,002

(22) PCT Filed: Nov. 30, 2011
(86) PCT No.: PCT/CN2011/083225

§ 371 Date: Dec. 2, 2011

(30) Foreign Application Priority Data
Nov. 18, 2011 (CN) 201103695672

(51) Int. Cl. F21V 21/00

(52) U.S. Cl. CPC F21V 21/00
USPC 362/432

(57) ABSTRACT

The present invention discloses a backplane, a backlight module and an LCD device. A backplane of a backlight module, comprising: a plurality of mutually joined brackets, and fixed grids which are fixed among the brackets and used for fixing functional clamping pieces of the backlight module. The functional clamping pieces are used for fixing components and parts of the backplane module, such as PCBs and the like. In the present invention, because the brackets and the fixed grids are adopted as basic members of the backplane, the brackets are used as main supporting components of the backplane; the fixed grids are fixed among the brackets; components and parts of the backlight module, such as PCBs, are fixed to the fixed grids. The brackets can be designed into universal sections; in using the brackets, the brackets are only cut and joined according to backplanes of different sizes. The fixed grids can also be designed into grids of standard sizes, and cut into the grids of different sizes according to actual needs; thus, the brackets and the fixed grids can achieve standardization and generalization and can form a standard and universal backplane, a backlight module and an LCD device.

### TECHNICAL FIELD

The present invention relates to the field of liquid crystal displays, and more particularly to a backplane, a backlight module and a liquid crystal display (LCD) device.

### BACKGROUND

The LCD device includes an LCD panel and a backlight module, wherein the bottom of the backlight module is provided with a backplane used for sealing the module and fixing a component in the module. In the existing backplanes, integral backplanes are used and are integrally formed in the mode of metal stamping or plastic injection, causing heavy products and high material cost of the products. For large-size backplanes, because larger stamping equipment is needed, the cost is higher, and because the corresponding die size is large and the structure is complicated, the die cost is also very high. With increasingly fierce market competition, it is more and more important to effectively reduce the design cost. As a result, the key research direction of each designer lies in saving the material cost and simplifying the assembly technology.

In addition, because different backlight modules have different component sizes and installing positions, the integral backplane cannot achieve standardized design, and has poor universality.

### SUMMARY

The aim of the present invention is to provide a standard and universal backplane, a backlight module and an LCD device.

The aim of the present invention is achieved by the following technical schemes.

A backplane of a backlight module, comprising: a plurality of mutually joined brackets, and fixed grids; the fixed grids are fixed among the brackets and used for fixing functional clamping pieces of the backlight module. The functional clamping pieces are used for fixing components and parts of the backplane module, such as PCBs and the like.

Preferably, the fixed grids comprise a plurality of ribs which intersect vertically and horizontally to form a plurality of meshes. Both ends of the ribs are respectively fixed to the different brackets. This is one specific structure of the fixed grids; standard ribs are adopted as basic members to form the fixed grids with simple structure and good universality.

Preferably, the ribs are rigid ribs which form a plurality of meshes with constant pore size. The rigid ribs have high strength, difficult deformation and good weight capacity. Moreover, the sizes of the meshes are constant; the locking piece is fixed to the meshes, causing high connection strength.

Preferably, the ribs are elastic ribs which form a plurality of meshes with variable pore sizes. The elastic ribs have good tenacity, and are suitable for locking pieces of different sizes and shapes within limits, with good universality.

Preferably, the multiple ribs are fixed in the intersection positions. After the ribs are fixedly connected in the intersection positions, the sizes of the meshes are constant; the locking piece is fixed to the meshes, causing high connection strength.

Preferably, the vertical and horizontal ribs mutually intersect. The intersection can enhance the strength of the backplane; moreover, the intersection points are not fixedly connected; therefore, the sizes of the meshes have a certain regulation range; the meshes are suitable for locking pieces of different sizes and shapes, with good universality.

Preferably, the multiple ribs are divided into two groups of vertical arrangement and horizontal arrangement; two groups of ribs are respectively fixed to both sides of said backplane. There is a certain spacing between vertical ribs and horizontal ribs; in each group of ribs, a chute is formed between two adjacent ribs, which is convenient for the functional clamping pieces to slide in the chute; when required to be fixed, the functional clamping pieces can also be directly fixed to the chute; thus, a more flexible fixing form can be provided.

Preferably, there are two layers of fixed grids which are respectively fixed to both sides of the backplane. Double-structural fixed grids have higher strength.

A backlight module, comprising: an aforementioned backplane; fixed grids of the backplane are provided with one or a plurality of functional clamping pieces.

Preferably, the functional clamping pieces comprise one or more of locking pieces and radiating pieces. This is a concrete form of the functional clamping pieces. The locking pieces are used for fixing components such as PCBs; the radiating pieces are used for radiating heat from a lamp source.

Preferably, the functional clamping pieces together with clamping parts for fixing the fixed grids are standard parts. The standard clamping parts can enhance the universality and facilitate cost reduction and the enhancement of production efficiency.

An LCD device comprises an aforementioned backlight module.

In the present invention, because the brackets and the fixed grids are adopted as basic members of the backplane, the brackets are used as main supporting components of the backplane; the fixed grids are fixed among the brackets; components and parts of the backlight module, such as PCBs, are fixed to the fixed grids. Then, firstly, the backplane bears load primarily by means of a frame, and the integral strength of the backplane is high; secondly, the brackets can be designed into universal sections; in using the brackets, the brackets are only cut and joined according to backplanes of different sizes. The fixed grids can also be designed into grids of standard sizes, and cut into the grids of different sizes according to actual needs; thus, the brackets and the fixed grids can achieve standardization and generalization and can form a standard and universal backplane, a backlight module and an LCD device.

### BRIEF DESCRIPTION OF FIGURES

FIG. 1 is a schematic diagram of a backplane of the present invention;

FIG. 2 is a schematic diagram of fixing PCBs through a backplane in the present invention;

FIG. 3 is a schematic diagram of the first locking piece in the example 1 of the present invention;

FIG. 4 is a schematic diagram of the second locking piece in the example 1 of the present invention;

FIG. 5 is a schematic diagram of the third locking piece in the example 1 of the present invention;

FIG. 6 is a schematic diagram of the fourth locking piece in the example 1 of the present invention;

FIG. 7 is a schematic diagram of the first locking piece in the example 2 of the present invention;

FIG. 8 is a schematic diagram of the second locking piece in the example 2 of the present invention;

FIG. 9 is a schematic diagram of the third locking piece in the example 2 of the present invention;

Wherein: 100. frame; 110. bracket; 111. upper bracket; 112. right bracket; 113. lower bracket; 114. left bracket; 115. central bracket; 115. central bracket; 130. reinforcement; 131. connecting part; 300. locking piece; 310. conical peak; 320. buckling claw; 330. threaded hole; 340. rivet; 350. screw; 400. fixed grid; 410. rib; 420. mesh; 430. functional clamping piece; 500. PCB.

### DETAILED DESCRIPTION

The present invention will further be described in detail in accordance with the figures and the preferred examples.

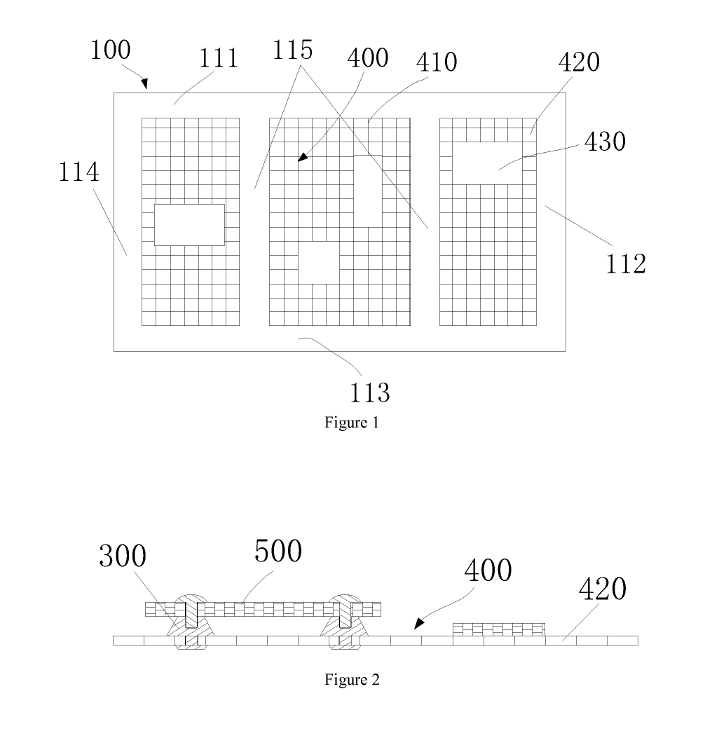

An LCD device, comprising: an LCD panel and a backlight module, wherein the bottom of the backlight module is provided with a backplane. The backplane comprises a frame 100 which comprises a plurality of brackets 110; the frame 100 is internally provided with grids. As shown in FIG. 1, the brackets 110 comprise an upper bracket 111, a lower bracket 113, a left bracket 114 and a right bracket 112 which are placed end to end to form a large frame 100 of the whole backplane; the large frame 100 is also internally provided with two central brackets 115; both ends of the central brackets 115 are respectively fixed to the upper and the lower brackets 110. The grids in the frame 100 are fixed to each bracket 110; PCBs 500 and other components of the backlight module are fixed on the grids through the functional clamping pieces 430; the functional clamping pieces 430 comprise one or more of locking pieces 300 and radiating pieces; the functional clamping pieces together with clamping parts for fixing the fixed grids 400 are standard parts for enhancing the universality and facilitating the cost reduction and the enhancement of the production efficiency. Certainly, under the condition of ensuring the strength of the frame 100, two central brackets 115 can be omitted to save the cost. Angular reinforcements 130 can be added in the joining positions of the brackets, and are arranged in four angular positions of the frame; each reinforcement 130 comprises two connecting parts 131 which are used for connecting and fixing with the brackets in the frame. The reinforcements 130 are integrally formed, have high strength, and can enhance the joining strength; moreover, the connecting parts 131 can be made into standard parts so that the brackets can be made into standard sections; the brackets are only cut according to backplanes of different sizes, with high universality. The reinforcements 130 can also be made into clamping type reinforcements to be fixed to the meshes 420 of the fixed grids 400.

The fixed grids 400 comprise a plurality of ribs 410 which intersect vertically and horizontally to form a plurality of meshes 420; both ends of the ribs 410 are respectively fixed to the different brackets 110. The ribs 410 can be rigid ribs 410 to form a plurality of meshes 420 with constant pore size. The ribs 410 can also be elastic ribs 410 to form a plurality of meshes 420 with variable pore sizes.

The multiple ribs 410 can be integrally formed or fixedly connected in the intersection to form fixed grids 400 for enhancing the strength of the grids. Certainly, the strength of the grids can also be enhanced by the mode that the vertical ribs 410 and the horizontal ribs 410 intersect; moreover, the sizes of the grids can have a certain adjustment space. The vertical ribs 410 and the horizontal ribs 410 can be respectively fixed to both sides of the backplane or fixed to the same side of the backplane.

In addition, two layers of fixed grids 400 can be set and respectively fixed to both sides of the backplane.

As shown in FIG. 2, taking the fixation of PCBs through the fixed grids 400 as an example, hillocks are arranged in the area where a circuit board needs to be fixed; the bottoms of the hillocks are fixed on the meshes 420 of the fixed grids 400 in the mode of riveting, screw fixation and the like; then, the PCB 500 is fixed on the hillocks.

### EXAMPLE 1

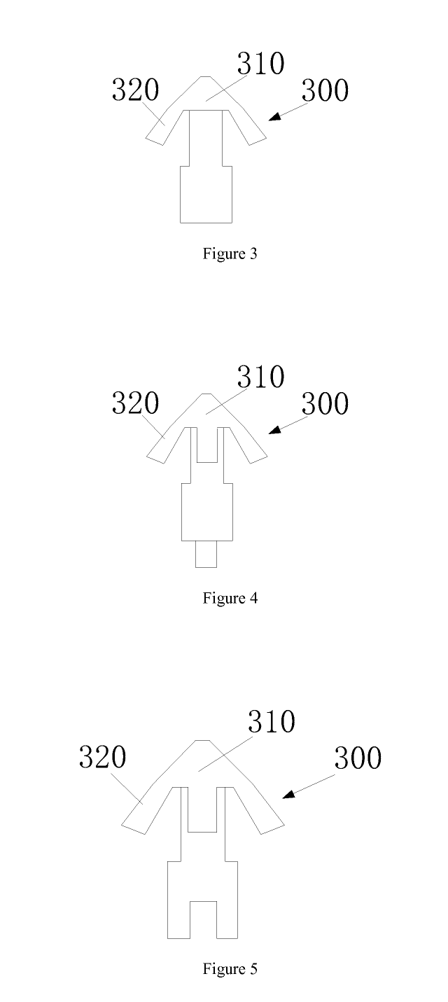

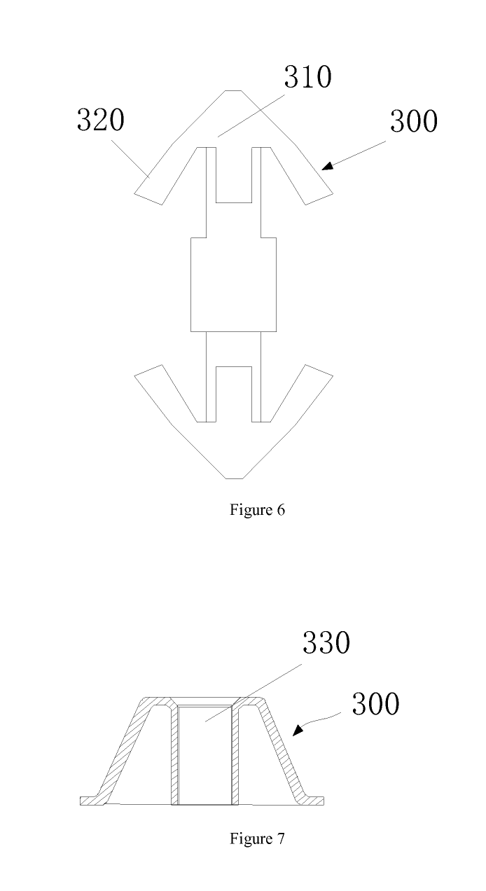

As shown in FIGS. 3 to 6, the top of the locking piece 300 fixed with the PCB is provided with a conical peak 310; more than two elastic buckling claws 320 extend out of the bottom of the peak to form a clamping structure for fixing the PCB 500; the locking piece 300 can be integrally formed by plastics.

The locking piece 300 and the backplane are provided with a fixed structure used for fixing the locking piece 300 to the backplane; the fixed structure can be in any form of riveting columns, screws or threaded holes, or the same clamping structure as the top; correspondingly, the backplane is provided with installing holes used for fixing the locking piece 300 which is installed on the backplane through the installing holes. The root of the locking piece 300 can be a plane which is unfixed with the backplane and only fixed with the PCBs 500 so as to perform a pure supporting action on the PCB 500.

### EXAMPLE 2

FIGS. 7 to 9 show another form of the locking piece 300—the hillocks existing as independent parts; the hillocks are not formed on the backplane in producing the backplane but installed in the relevant positions of the backplane 400 in needing to use the hillocks so as to achieve the purpose of flexibly using the hillocks to locate the components of various dimensions of PCBs 500 and the like.

As shown in FIG. 7, the hillock has a threaded hole 330 used for installing and fixing components of PCBs 500 and the like, and the threaded hole 330 always penetrates through the independent hillock. Thus, the independent hillock can be fixed on the backplane 400 from the lower part through a screw 350, and can fix the PCB 500 from the upper part. Accordingly, the backplane 400 is provided with hillock installing holes, such as through holes or chutes, of which the size is corresponding to that of the threaded hole 330 of the hillock, so that the hillock can be fixed on the backplane 400. Similarly, the PCB 500, the hillock and the backplane are fixed by using only one screw matching with a nut.

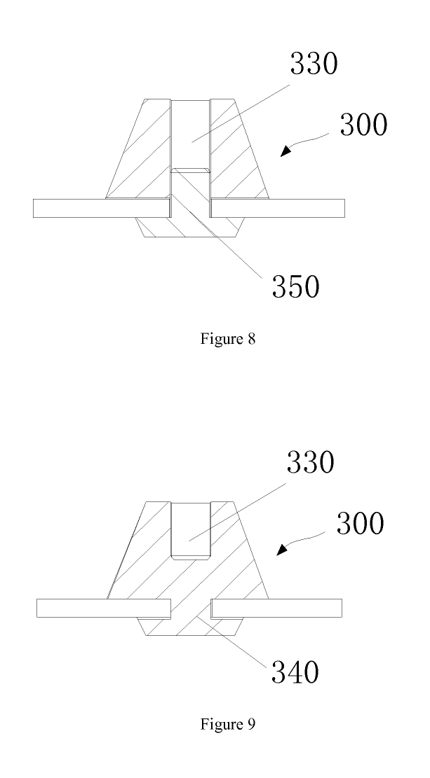

As shown in FIG. 8, the PCB 500 can be fixed to the hillock through a screw 350; similarly, the hillock is fixed to the backplane through the screw 350 and a nut.

In order to facilitate installation, the hillock can be set into a similar structure to the rivet, namely the rivet and the hillock are integrally formed; as shown in FIG. 9, the connection of the lower part of the hillock with the backplane 400 is in a riveting form, namely the hillock is riveted to the backplane 400 through the rivet 340. The riveting mode is quicker than the screwed connection mode, can be finished through a machine, and improves the production efficiency.

The hillock is fixed on the backplane 400 through the rivet 340, and then the PCB 500 is fixed on the hillock through the screw 350 so that the PCB 500 is locked.

To save material and facilitate processing, the hillock can be formed by directly stamping a panel. As shown in FIG. 10, the inside of the hillock is of a hollow structure, and the whole hillock is made of panel material, which saves material and facilitates production.

Certainly, the shape of the independent hillock in the example is not limited to the conical section shape shown in the figure; other shapes such as square can also achieve the corresponding purpose.

In the example, corresponding hillocks are arranged in corresponding positions in accordance with the size of the PCB 500 of the backlight module; meanwhile, the number of corresponding hillocks is set according to the components of PCBs 500 of different numbers.

The present invention is described in detail in accordance with the above contents with the specific preferred examples. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A backplane of a backlight module, comprising: a plurality of mutually joined brackets, and fixed grids, wherein the fixed grids are fixed among the brackets and used for fixing functional clamping pieces of said backlight module.

2. The backplane of the backlight module of claim 1, wherein said fixed grids comprise a plurality of ribs; the multiple ribs intersect vertically and horizontally to form a plurality of meshes; both ends of said ribs are respectively fixed to said different brackets.

3. The backplane of the backlight module of claim 2, wherein said ribs are rigid ribs and form a plurality of meshes with constant pore size.

4. The backplane of the backlight module of claim 2, wherein said ribs are elastic ribs and form a plurality of meshes with variable pore sizes.

5. The backplane of the backlight module of claim 2, wherein said multiple ribs are fixed in the intersection positions.

6. The backplane of the backlight module of claim 2, wherein said vertical and horizontal ribs mutually intersect.

7. The backplane of the backlight module of claim 2, wherein said multiple ribs are divided into two groups of vertical arrangement and horizontal arrangement; two groups of ribs are respectively fixed to both sides of said backplane.

8. The backplane of the backlight module of claim 1, wherein there are two layers of fixed grids; said fixed grids are respectively fixed to both sides of said backplane.

9. A backlight module, comprising: the backplane of claim 1; said backplane comprises a plurality of mutually joined brackets, and fixed grids, wherein said fixed grids are fixed among said brackets and used for fixing functional clamping pieces of said backlight module; the fixed grids of said backplane are provided with one or a plurality of functional clamping pieces.

10. The backlight module of claim 9, wherein said fixed grids comprise a plurality of ribs; said multiple ribs intersect vertically and horizontally to form a plurality of meshes; both ends of said ribs are respectively fixed to said different brackets.

11. The backlight module of claim 10, wherein said multiple ribs are fixed in the intersection positions.

12. The backlight module of claim 10, wherein said vertical and horizontal ribs mutually intersect.

13. The backlight module of claim 10, wherein said multiple ribs are divided into two groups of vertical arrangement and horizontal arrangement; two groups of ribs are respectively fixed to both sides of said backplane.

14. The backlight module of claim 9, wherein there are two layers of fixed grids; said fixed grids are respectively fixed to both sides of said backplane.

15. The backlight module of claim 9, wherein said functional clamping pieces comprise one or more of locking pieces and radiating pieces.

16. The backlight module of claim 9, wherein said functional clamping pieces together with clamping parts for fixing said fixed grids are standard parts.

17. An LCD device, comprising: the backlight module of claim 9; said backlight module comprises a backplane; said backplane comprises a plurality of mutually joined brackets, and fixed grids; said fixed grids are fixed among said brackets and used for fixing functional clamping pieces of said backlight module; the fixed grids of said backplane are provided with one or a plurality of functional clamping pieces.

18. The LCD device of claim 17, wherein said fixed grids comprise a plurality of ribs; said multiple ribs intersect vertically and horizontally to form a plurality of meshes; both ends of said ribs are respectively fixed to said different brackets.

19. The LCD device of claim 18, wherein said multiple ribs are fixed in the intersection positions.

20. The LCD device of claim 18, wherein said multiple ribs are divided into two groups of vertical arrangement and horizontal arrangement; two groups of ribs are respectively fixed to both sides of said backplane.

21. The LCD device of claim 17, wherein there are two layers of fixed grids; said fixed grids are respectively fixed to both sides of said backplane.
